(19) United States
(12) Patent Application Publication
(10) Pub. No.: US 2011/0312239 A1
(43) Pub. Date: Dec. 22, 2011

(54) PAPERMAKING FELT

(75) Inventors: Hirofumi Ishii, Tokyo (JP); Yasuhiko Kobayashi, Tokyo (JP)

(73) Assignee: ICHIKAWA CO., LTD., Tokyo (JP)

(21) Appl. No.: 13/203,248

(22) PCT Filed: Feb. 25, 2010
(86) PCT No.: PCT/JP2010/001285

§ 371 Date: Aug. 25, 2011

(30) Foreign Application Priority Data
Feb. 26, 2009 (JP) 2009-043542

(51) Int. Cl. B32B 5/26

(52) U.S. Cl. 442/246; 442/326

(57) ABSTRACT

A papermaking felt which, in a papermaking machine, has good water squeezing capability (water permeability) and durability with regard to flattening and which also has excellent wet paper web smoothing properties and resistance to fiber loss. The papermaking felt is made by stacking and intertwiningly integrating by needling a substrate, a first batt fiber layer disposed on the wet paper web side of the substrate, and a second batt fiber layer disposed on the machine side of the substrate; wherein the substrate is made from a plurality of reinforcing materials, the reinforcing materials include a spunyarn, and due to the intertwining with a batt fiber layer, the spunyarn is integrated to such a degree that the yarn shape disappears.

### TECHNICAL FIELD

The present invention relates to a papermaking felt (hereinafter also simply referred to as “felt”) used in a papermaking machine. More particularly, the present invention relates to a papermaking felt for squeezing moisture out of a wet paper sheet which is pressed in the press part of a papermaking machine.

The object of the present invention is to provide a papermaking felt with good water squeezing capability and wet paper web smoothing properties and which also has excellent resistance to batt fiber loss, and more particularly to provide a papermaking felt which is suitable for high speed traveling of a papermaking machine, and which has good wet paper web smoothing properties.

### BACKGROUND ART

Roughly speaking, the papermaking process of a papermaking machine comprises three parts for forming, pressing and drying, respectively, during which moisture is continuously removed. In each part, papermaking equipment corresponding to the dewatering function is used. In the press part, a papermaking felt is used.

Conventionally, papermaking felts perform the tasks of squeezing water from the wet paper web (dewatering), of increasing the smoothness of the wet paper web (smoothening) and of transferring the wet paper web (wet paper web transfer); it is the basic function of the felt to balance these tasks.

When the wet paper web passes between a pair of press rolls, the moisture in the wet paper web moves to the felt due to the pressure applied and is then either discharged from a rear face of the felt or sucked in by a suction box of the papermaking machine and discharged to the outside of the felt system. Therefore, water permeability and the function of recovering without flattening (flattening resistance) when pressure is removed from a felt which has been compressed by an applied pressure are important features of a felt. The ability to maintain these functions beginning with the time the felt is first used is also important.

Most papermaking felts in use are either of the batt-on-base type or the batt-on-mesh type, in which a batt fiber web is flocked by a needle-punch technique on a woven fabric (substrate). Recently, the use of the batt-on-mesh type has come to be preferred because of the increased speed of papermaking machines, and the wet paper web smoothness and the resistance to fiber loss of the batt fibers have come to be considered as important properties.

Patent document 1 proposes to prevent the flattening of the felt by increasing the ratio of the substrate part. One method of increasing the ratio of the substrate part is to stack and intertwiningly integrate by needling a plurality of endless woven fabrics, made by hollow weave or the like, or base fabrics, made endless by joining together both ends of an open-ended substrate, and a batt fiber layer. However, when the ratio of the substrate part is high, the transfer of base fabric marking to the wet paper web increases, and there are cases in which the wet paper web smoothness deteriorates.

Patent document 2 is an example of how the wet paper web smoothness is improved in the prior art. This is a felt structure in which a non-woven fabric, wherein yarns are arranged substantially in parallel to each other exclusively in the lateral direction, is inserted in between two or more superimposed woven fabrics. The inserted non-woven fabric has the function of avoiding that the knuckle parts (the ups and downs of the yarn due to the weaving of the MD and CMD yarns) of the woven fabric and the MD yarns have an influence on wet paper web smoothness. There is, however, the disadvantage that the water squeezing capability and the ease of installing the felt deteriorate because the basis weight of the felt increases with a structure using such a non-woven fabric.

Another prior art example for improving wet paper web smoothness is Patent document 3, which proposes a felt wherein two or more substrates (woven fabrics) are stacked together, and at least 1 substrate (woven fabric) thereof is a woven fabric woven from a twine and a single yarn having a specific fineness, so that the twine turns into a flat cord when woven. This felt is characterized by good wet paper web smoothness and excellent resistance to flattening.

### CITATION LIST

### Patent Literature

[Patent document 1] JP A, 06-280183
[Patent document 2] JP A, 2003-13385
[Patent document 3] JP A, 2005-200819

### SUMMARY OF INVENTION

### Technical Problem

Together with the higher operating speed of papermaking machines and the higher pressure applied by the roll press or the shoe press in the press part, which are due to the increased productivity of the papermaking industry, the environment in which felts are used has become increasingly harsher in recent years. As a result, there are the problems of flattening of papermaking felts under high pressure, a reduction in water permeability, resistance to flattening or the like, and a remarkable deterioration of the water squeezing capability.

At the same time, it has to be feared that since the loss of the batt fibers accompanying the increase in speed of papermaking machines comes to the face, this will have an influence on paper quality.

Consequently, apart from the water squeezing capability, wet paper web smoothing property and resistance to flattening mentioned above, resistance to batt fiber loss is also a property that is required of a felt to the higher degree.

The object of the present invention is to do away with the above-mentioned disadvantages and to provide a papermaking felt which, in a papermaking machine, has good water squeezing capability (water permeability) and durability with regard to flattening and which also has excellent wet paper web smoothing properties and resistance to fiber loss.

### Solution to Problem

As a result of intensive research, the present inventors arrived at the invention of a papermaking felt; wherein a substrate is made from a plurality of reinforcing materials, the reinforcing materials comprise a spun yarn, and the spun yarn is integrated by intertwining with a batt fiber layer to such a degree that the yarn shape disappears.

In other words, the present invention is

1. a papermaking felt made by stacking and intertwiningly integrating by needling a substrate of a papermaking felt, a first batt fiber layer disposed on the wet paper web side of the substrate and a second batt fiber layer disposed on the machine side of the substrate; wherein the substrate is made from a plurality of reinforcing materials, the reinforcing material adjacent to the first batt fiber layer comprises a spun yarn, and due to the intertwining with the first batt fiber layer, the spun yarn is integrated to such a degree that the yarn shape disappears.

The present invention is also

2. a papermaking felt made by stacking and intertwiningly integrating by needling a substrate of a papermaking felt, a first batt fiber layer disposed on the wet paper web side of the substrate and a second batt fiber layer disposed on the machine side of the substrate; wherein the substrate is made from a plurality of reinforcing materials, the reinforcing material adjacent to the second batt fiber layer comprises a spun yarn, and due to the intertwining with the second batt fiber layer, the spun yarn is integrated to such a degree that the yarn shape disappears.

The present invention further is

3. a papermaking felt according to 1. or 2.; wherein the reinforcing material comprises a spun yarn, and this spun yarn is disposed in the traveling direction (machine direction) of the papermaking felt.

The present invention also is

4. a papermaking felt according to 1. or 2.; wherein the reinforcing material comprises a spun yarn, and this spun yarn is disposed in the lateral direction (cross machine direction) of the papermaking felt.

The present invention further is

5. a papermaking felt according to any one of 1. to 4.; wherein the substrate is made from two or more woven reinforcing materials of different or identical type(s).

In the present invention, the phrase “due to the intertwining with the batt fiber layer, the spun yarn is integrated to such a degree that the yarn shape disappears” means that, while the spun yarn is disposed in the traveling direction (MD) and/or the lateral direction (CMD), it is intertwiningly integrated to such a degree that it is substantially impossible to recognize the orientation thereof by visual observation. In other words, the spun yarn and the batt fibers are integrated into each other so that the batt fibers are intertwined in the spun yarn and it is not possible to see the yarn shape.

Spun yarns of relatively thick staple fibers with a fineness in the range of, for example, 10 to 50 dtex increase the capability of intertwining with the batt fibers and improve resistance to fiber loss of the batt fibers.

According to the present invention, it is easier to achieve the above object when a loosely twisted spun yarn is used, which preferably has a number of twists of 5 to 50 times per one meter, or more preferably 10 to 30 times per one meter. When the number of twists exceeds 50 times, the capability of intertwining with the batt fibers deteriorates because the stiffness of the yarn increases.

According to the present invention, the substrate is composed of a stacked reinforcing material of two or more woven reinforcing materials of different of identical type(s). The stacked reinforcing material is preferably made from a woven fabric of a single weave as upper fabric and a woven fabric of a single or multiple weave as lower fabric. In this case, the lower fabric gives mechanical strength to the felt and the upper fabric is for the wet paper web smoothness and the resistance to batt fiber loss.

The source material for the spun yarn according to the present invention is preferably one or a plurality of material(s) selected from the group consisting of polyamide, polyester, aromatic polyamide, aromatic polyester and polyether ketone, which are excellent from the viewpoint of strength and durability.

### Advantageous Effects of Invention

A papermaking felt according to the present invention is characterized in that the reinforcing material comprises a spun yarn, and, due to the intertwining with the batt fiber layer, the spun yarn is integrated to such a degree that the yarn shape disappears; therefore, due to the integration of the batt fiber and the spun yarn, the yarn shape becomes flat and does not leave a mark on the wet paper web, and the ups and downs (unevenness) of the yarns at the interlacing points (knuckle parts) where the yarns of the reinforcing material intersect each other can be reduced. Consequently, the water squeezing capability (water permeability) and durability with regard to flattening is good, and the wet paper web smoothness is further increased. The resistance to batt fiber loss is also very high, because the integration of the spun yarn and the batt fiber is strong.

### BRIEF DESCRIPTION OF DRAWINGS

FIG. 1 is a cross-sectional view of a conventional general papermaking felt.

FIG. 2 is a cross-sectional view of a papermaking felt showing one embodiment of the present invention.

FIG. 3 is a cross-sectional view of a papermaking felt showing another embodiment of the present invention.

FIG. 4 is a cross-sectional view of a papermaking felt showing still another embodiment of the present invention.

FIG. 5 is a cross-sectional view of a papermaking felt showing yet another embodiment of the present invention.

### DESCRIPTION OF EMBODIMENTS

A general felt will be described with reference to FIG. 1. A papermaking felt 10 is formed into an endless shape and comprises a substrate 20, made from woven fabrics or the like, a first batt fiber layer (disposed on the wet paper web side of the substrate 20) 30, intertwiningly integrated with the substrate 20 by needle-punching, and a second batt fiber layer (disposed on the machine side of the substrate 20) 31. The substrate 20 gives mechanical strength to the felt 10. In FIG. 1, a woven fabric obtained by weaving a felt traveling direction (MD) yarn 50 and a felt lateral direction (CMD) yarn 40 is used as substrate 20.

Yarn materials constituting the substrate (woven fabric) of normal felts that can be used as MD yarn 50 and CMD yarn 40 are, for example, single monofilament yarns, monofilament twines and multi-filaments. With regard to batt fiber layer, the staple fibers constituting the batt fiber layer of normal felts can, for example, be one or a plurality of materials selected from the group consisting of polyamide, polyester, aromatic polyamide, aromatic polyester and polyether ketone.

The felt 10, as mentioned above, is used in the press part of a papermaking machine (not shown in the drawings). In the papermaking machine, the felt 10 is disposed around a plurality of guide rollers under tension. Then, water is squeezed out by applying a high pressure on the felt 10 together with the wet paper web in a press part, composed of a pair of press rolls or a press roll and a shoe. The felt 10 travels by following the rotation of the press roll.

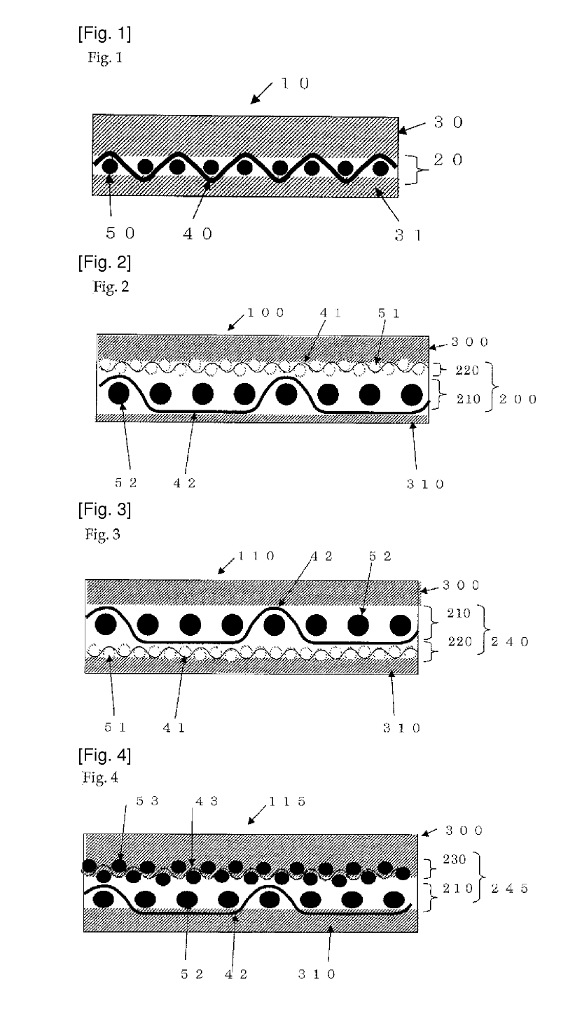

One embodiment of the present invention will be described with reference to FIG. 2. First, a papermaking felt 100 according to the present invention comprises a substrate 200, a first batt fiber layer (disposed on the wet paper web side of the substrate 200) 300 intertwiningly integrated with the substrate 200 by needle-punching, and a second batt fiber layer (disposed on the machine side of the substrate 200) 310. The batt fiber layers 300, 310 are formed by intertwiningly integrating batt fibers with the substrate 200 by needle-punching.

The substrate 200 is made from two reinforcing materials, namely reinforcing material A (210) and reinforcing material B (220). One of these reinforcing materials, i.e. reinforcing material A (210), gives mechanical strength to the felt 100; the material is not particularly limited, as long as sufficient strength can be achieved, different types of material may be used. In FIG. 2, the reinforcing material B (220) is of a different type than the reinforcing material A (210) to which it is stacked; however, the reinforcing material B (220) may also be of the same type as long as the requirements of the present invention are met.

Here, reinforcing material A (210) can, for example, be a woven fabric obtained by weaving an MD yarn 52 and a CMD yarn 42. It is also possible to use a reinforcing material obtained by forming a woven fabric having a width that is narrower than the felt to be produced and that is made from the MD yarn 52 and the CMD yarn 42, by winding this woven fabric into a spiral, and by joining adjacent edge parts of the woven fabric to each other. A reinforcing material obtained by coaxially winding a woven fabric having a width that is substantially identical to the width of the felt to be produced and that is made from the MD yarn 52 and the CMD yarn 42 may also be used. Apart from reinforcing materials made from a woven fabric, reinforcing materials obtained by fixing the MD yarn 52 with an adhesive, or reinforcing material in which the MD yarn 52 and the CMD yarn 42 are merely layered without being woven may also be used.

According to the present invention, apart from the reinforcing material A (210), there is another reinforcing material, i.e. reinforcing material B (220), which is stacked to the wet paper web side of the reinforcing material A (210) to constitute the whole of the substrate 200. The reinforcing material B (220) is adjacent to the first batt fiber layer 300, which is disposed on the wet paper web side of the substrate 200, the MD yarn 51 is a spun yarn, which is a feature of the present invention, and the CMD yarn 41 is a yarn material for making the substrate (woven fabric) of normal felts.

The MD yarn 51 according to the present invention is integrated to such a degree that the yarn shape disappears due to the intertwining with the first batt fiber layer 300; therefore, in FIG. 2, the MD yarn 51 is shown as an MD yarn ghost; in reality, it is intertwiningly integrated with the batt fiber layer to such a degree that it cannot be recognized by visual observation.

FIG. 3 shows another embodiment of the invention. A papermaking felt 110 according to the present invention comprises a substrate 240, a first batt fiber layer (disposed on the wet paper web side of the substrate 240) 300 intertwiningly integrated with the substrate 240 by needle-punching, and a second batt fiber layer (disposed on the machine side of the substrate 240) 310. The batt fiber layers 300, 310 are formed by intertwiningly integrating batt fibers with the substrate 240 by needle-punching.

The substrate 240 is made from two reinforcing materials, namely reinforcing material A (210) and reinforcing material B (220). One of these reinforcing materials, i.e. reinforcing material A (210), gives mechanical strength to the felt 110; the material is not particularly limited, as long as sufficient strength can be achieved, different types of material may be used. For example, the same materials as for the reinforcing material A (210) in FIG. 2 may be used. In FIG. 3, the reinforcing material B (220) is of a different type than the reinforcing material A (210) to which it is stacked; however, the reinforcing material B (220) may also be of the same type as long as the requirements of the present invention are met.

According to the present invention, apart from the reinforcing material A (210), there is another reinforcing material, i.e. reinforcing material B (220), which is stacked to the machine side of the reinforcing material A (210) to constitute the whole of the substrate 240. The reinforcing material B (220) is adjacent to the second batt fiber layer 310, which is disposed on the machine side of the substrate 240, the MD yarn 51 is a spun yarn, which is a feature of the present invention, and the CMD yarn 41 is a yarn material for making the substrate (woven fabric) of normal felts.

The MD yarn 51 according to the present invention is integrated to such a degree that the yarn shape disappears due to the intertwining with the second batt fiber layer 310; therefore, in FIG. 3, the MD yarn 51 is shown as an MD yarn ghost; in reality, it is intertwiningly integrated with the batt fiber layer to such a degree that it cannot be recognized by visual observation.

FIG. 4 shows still another embodiment of the invention. A papermaking felt 115 according to the present invention comprises a substrate 245, a first batt fiber layer (disposed on the wet paper web side of the substrate 245) 300 intertwiningly integrated with the substrate 245 by needle-punching, and a second batt fiber layer (disposed on the machine side of the substrate 245) 310. The batt fiber layers 300, 310 are formed by intertwiningly integrating batt fibers with the substrate 245 by needle-punching.

The substrate 245 is made from two reinforcing materials, namely reinforcing material A (210) and reinforcing material C (230). One of these reinforcing materials, i.e. reinforcing material A (210), gives mechanical strength to the felt 115; the material is not particularly limited, as long as sufficient strength can be achieved, different types of material may be used. For example, the same materials as for the reinforcing material A (210) in FIG. 2 may be used. In FIG. 4, the reinforcing material C (230) is of a different type than the reinforcing material A (210) to which it is stacked; however, the reinforcing material C (230) may also be of the same type as long as the requirements of the present invention are met.

According to the present invention, apart from the reinforcing material A (210), there is another reinforcing material, i.e. reinforcing material C (230), which is stacked to the wet paper web side of the reinforcing material A (210) to constitute the whole of the substrate 245. The reinforcing material C (230) is adjacent to the first batt fiber layer 300, which is disposed on the wet paper web side of the substrate 245, the CMD yarn 43 is a spun yarn, which is a feature of the present invention, and the MD yarn 53 is a yarn material for making the substrate (woven fabric) of normal felts.

The CMD yarn 43 according to the present invention is integrated to such a degree that the yarn shape disappears due to the intertwining with the first batt fiber layer 300; therefore, in FIG. 4, the CMD yarn 43 is shown as a CMD yarn ghost; in reality, it is intertwiningly integrated with the batt fiber layer to such a degree that it cannot be recognized by visual observation.

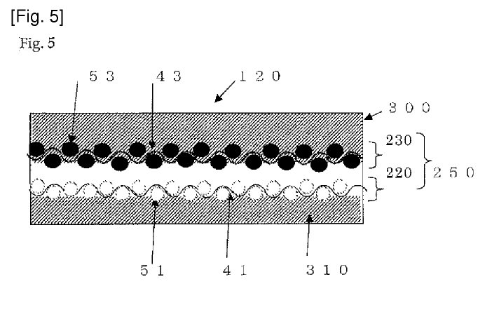

FIG. 5 shows yet another embodiment of the invention. A papermaking felt 120 according to the present invention comprises a substrate 250, a first batt fiber layer (disposed on the wet paper web side of the substrate 250) 300 intertwiningly integrated with the substrate 250 by needle-punching, and a second batt fiber layer (disposed on the machine side of the substrate 250) 310. The batt fiber layers 300, 310 are formed by intertwiningly integrating batt fibers with the substrate 250 by needle-punching.

The substrate 250 is made from two reinforcing materials, namely reinforcing material B (220) and reinforcing material C (230). One of these reinforcing materials, i.e. reinforcing material B (220), is adjacent to the second batt fiber layer 310, which is disposed on the machine side of the substrate 250, the MD yarn 51 is a spun yarn, which is a feature of the present invention, and the CMD yarn 41 is a yarn material for making the substrate (woven fabric) of normal felts. The MD yarn 51 according to the present invention is integrated to such a degree that the yarn shape disappears due to the intertwining with the second batt fiber layer 310; therefore, in FIG. 5, the MD yarn 51 is shown as an MD yarn ghost; in reality, it is intertwiningly integrated with the batt fiber layer to such a degree that it cannot be recognized by visual observation.

According to the present invention, apart from the reinforcing material B (220), there is another reinforcing material, i.e. reinforcing material C (230), which is stacked to the wet paper web side of the reinforcing material B (220) to constitute the whole of the substrate 250. The reinforcing material C (230) is adjacent to the first batt fiber layer 300, which is disposed on the wet paper web side of the substrate 250, the CMD yarn 43 is a spun yarn, which is a feature of the present invention, and the MD yarn 53 is a yarn material for making the substrate (woven fabric) of normal felts. The CMD yarn 43 according to the present invention is integrated to such a degree that the yarn shape disappears due to the intertwining with the first batt fiber layer 300; therefore, in FIG. 5, the CMD yarn 43 is shown as a CMD yarn ghost; in reality, it is intertwiningly integrated with the batt fiber layer to such a degree that it cannot be recognized by visual observation.

In FIG. 5, a spun yarn, which is a feature of the present invention, is used in the reinforcing material B (220) and the reinforcing material A (230); however, the CMD yarn 41 in reinforcing material B (220) is a normal yarn material; therefore, sufficient strength can be achieved in the cross-machine direction (CMD).

Moreover, the MD yarn 53 in reinforcing material C (230) is a normal yarn material; therefore, sufficient strength can be achieved in the machine direction (MD). Consequently, the substrate 250 is composed so that sufficient strength can be achieved in the machine direction (MD) and cross-machine direction (CMD).

### EXAMPLES

Hereinafter, specific examples of the present invention will be described. In Examples 1 to 3 and in Comparative Example 1, reinforcing material A (210) and one more reinforcing material are stacked together to compose the whole of the substrate; reinforcing material A (210) has the following constitution:

The constitution of reinforcing material A (210)

(1) MD yarn 52 and CMD yarn 42

The following twines are common to both the MD yarn 52 and the CMD yarn 42.

(2) Twisting condition: “3/2/330” (wherein the values represent “the number of preliminary-twisted filaments for final twisting/the number of single filaments for preliminary twisting/fineness of the single yarns=dtex”, respectively)

(3) Preliminary twist: S direction 200 times/m

(4) Final twist: Z direction 130 times/m

(5) Weaving: a 3/1 hollow single woven fabric was woven from the MD yarn 52 (40 rows/5 cm) and the CMD yarn 42 (34 rows/5 cm).

### Example 1

As shown in FIG. 2, a felt 100 was manufactured by stacking a first batt fiber layer 300 and a second batt fiber layer 310 onto a substrate 200, made by stacking the below-mentioned reinforcing material B (220), to the wet paper web side of the reinforcing material A (210). As batt layers, the first batt fiber layer 300, with a basis weight of 300 g/m², and the second batt fiber layer 310, with a basis weight of 100 g/m², were stacked and intertwiningly integrated with the substrate 200 by needle-punching.

The constitution of the reinforcing material B (220)
(1) MD yarn 51: the following spun yarn was used:
(a) spun yarn: spun yarn of nylon 6 staple fibers with a fineness of 40 dtex
(b) number of twists: 10 times/m twisted in the Z direction.
(2) CMD yarn 41: nylon 6 single monofilament yarn with a fineness of 500 dtex
(3) Weaving: a 1/1 hollow single woven fabric was woven from the MD yarn 51 (30 rows/5 cm) and the CMD yarn 41 (40 rows/5 cm).

### Example 2

A felt with the same structure as in Example 1 was manufactured, except that a substrate 240 was formed by stacking the reinforcing material B (220) to the machine side of reinforcing material A (210).

### Example 3

A felt with the same structure as in Example 1 was manufactured, except that a substrate 245 was formed by replacing the reinforcing material B (220) with the following reinforcing material C (230).

The constitution of the reinforcing material C (230):

(1) MD yarn 53: nylon 6 single monofilament yarn with a fineness of 500 dtex

(2) CMD yarn 43: the following spun yarn was used:

(a) spun yarn: spun yarn of nylon 6 staple fibers with a fineness of 10 dtex

(b) number of twists: 40 times/m twisted in the Z direction.

(3) Weaving: a 1/1 hollow single woven fabric was woven from MD yarn 53 (40 rows/5 cm) and CMD yarn 43 (34 rows/5 cm).

### Example 4

A felt was manufactured with the same structure as in Example 3, except that a substrate 250 was formed by replacing the reinforcing material A (210) with the reinforcing material B (220).

### Comparative Example 1

A felt was manufactured with the same structure as in Example 1, except that a substrate for the Comparative Example was formed by stacking the following reinforcing material D to the wet paper web side of the reinforcing material A (210). The constitution of reinforcing material D:

(1) MD yarn: nylon 6 single monofilament yarn with a fineness of 500 dtex

(2) CMD yarn: the following twisted yarn was used:

(a) Twisting condition: “2/2/220” (wherein the values represent “the number of preliminary-twisted filaments for final twisting/the number of single filaments for preliminary twisting/fineness of the single yarns=dtex”, respectively)

(b) preliminary twist: S direction 250 times/m

(c) final twisting: Z direction 160 times/m

(3) Weaving: a 1/1 hollow single woven fabric was woven from MD yarn (40 rows/5 cm) and CMD yarn (34 rows/5 cm).

The flattening resistance (compression fatigue properties), wet paper web smoothness and resistance to fiber loss of the papermaking felts manufactured according to Examples 1 to 4 and Comparative Example 1 were evaluated according to the following methods.

(1) Flattening Resistance (Compression Fatigue Properties)

A 10 Hz pulse load of 1500 kN/cm² was applied 200,000 times to a papermaking felt test sample by a fatigue testing machine (servo pulsar compression testing machine manufactured by Shimadzu Corporation), and the flattening resistance was evaluated by the ratio of the felt density after and before the test. A lower value indicates a better flattening resistance. A high speed-high pressure type papermaking machine requires papermaking felts with a flattening resistance of 1.5 or less.

(2) Wet Paper Web Smoothness

Prescale pressure sensitive paper was placed on the papermaking felt test samples (on the wet paper web surface side), a pressure of 100 kN/cm² was applied, and the wet paper web smoothness was evaluated by visual observation of the unevenness in the felt surface transferred to the pressure sensitive paper. Thus, it was possible to verify the markings produced by the wet paper web-side surface of the substrate (the unevenness of yarn shape and the knuckle parts).

(3) Resistance to Fiber Loss

The resistance to fiber loss of the papermaking felts was evaluated by measuring the amount of fibers lost from the test samples by a TABER abrasion tester according to JIS 1023-1992. A disk-shaped sample was placed on a rotating turntable in the TABER abrasion tester, a rotating roll with a big frictional resistance was further brought into contact with the top of the sample, then the amount of the lost batt fiber of the felt was measured. With this tester, after a wheel of 1 kg was rotated 3000 times, the amount of lost fibers (mg) was measured. Both the wet paper web-side surface and the machine-side surface of the samples were measured, and the average value thereof was used.

The evaluation of the papermaking felts according to the Examples and the Comparative Examples is shown in the Table.

TABLE 1

| | Flatten- | | Resistance |
|---|---|---|---|
| | ing re- | | to fiber |
| | sistance | Wet paper web surface smoothness | loss (mg) |
| Example 1 | 1.35 | No markings. Good. | 60 |
| Example 2 | 1.35 | Slight markings due to reinforcing | 70 |
| | | material A were observed. Fairly good. | |
| Example 3 | 1.32 | No markings. Good. | 70 |
| Example 4 | 1.37 | No markings. Good. | 50 |
| Compar- | 1.30 | Strong markings due to reinforcing | 100 or |
| ative | | material A and D were observed. Not | more |
| Example 1 | | good. | |

The results in the Table clearly show that, compared to the felt of the Comparative Example, the felts according to the present invention of the Examples had excellent wet paper web smoothness and resistance to fiber loss, and were of the same level with regard to flattening resistance.

### INDUSTRIAL APPLICABILITY

According to the present invention, it is possible to obtain a felt in which the resistance to flattening can be preserved and which has excellent wet paper web smoothness and resistance to fiber loss. When this felt is used as a papermaking felt, the resistance to flatting due to the pressure applied by a roll, a shoe, or the like, in the papermaking process is maintained and a high water squeezing capability can be continued for a long time. The present invention provides a high performance felt having excellent wet paper web smoothness and resistance to fiber loss for the high speed and high pressure operations required of papermaking machines in recent years.

### REFERENCE SIGNS LIST

10, 100, 110, 115, 120: Papermaking felt
20, 200, 240, 245, 250: Substrate
30, 300: First batt fiber layer
31, 310: Second batt fiber layer
210: Reinforcing material A
220: Reinforcing material B
230: Reinforcing material C
50, 52: MD yarn
40, 41, 42: CMD yarn
43: CMD yarn ghost
51: MD yarn ghost

1. A papermaking felt made by stacking and intertwiningly integrating by needling a substrate of a papermaking felt, a first batt fiber layer disposed on the wet paper web side of the substrate and a second batt fiber layer disposed on the machine side of the substrate; wherein the substrate is made from a plurality of reinforcing materials, the reinforcing material adjacent to the first batt fiber layer comprises a spun yarn, and due to the intertwining with the first batt fiber layer, the spun yarn is integrated to such a degree that the yarn shape disappears.

2. A papermaking felt made by stacking and intertwiningly integrating by needling a substrate of a papermaking felt, a first batt fiber layer disposed on the wet paper web side of the substrate and a second batt fiber layer disposed on the machine side of the substrate; wherein the substrate is made from a plurality of reinforcing materials, the reinforcing material adjacent to the second batt fiber layer comprises a spun yarn, and due to the intertwining with the second batt fiber layer, the spun yarn is integrated to such a degree that the yarn shape disappears.

3. A papermaking felt according to claim 1;
wherein the reinforcing material comprises a spun yarn and this spun yarn is disposed in the traveling direction (machine direction) of the papermaking felt.

4. A papermaking felt according to claim 1; wherein the reinforcing material comprises a spun yarn and this spun yarn is disposed in the lateral direction (cross machine direction) of the papermaking felt.

5. A papermaking felt according to claim 1; wherein the substrate is made from two or more woven reinforcing materials of different or identical type(s).

6. A papermaking felt according to claim 2; wherein the reinforcing material comprises a spun yarn and this spun yarn is disposed in the traveling direction (machine direction) of the papermaking felt.

7. A papermaking felt according to claim 2; wherein the reinforcing material comprises a spun yarn and this spun yarn is disposed in the lateral direction (cross machine direction) of the papermaking felt.

8. A papermaking felt according to claim 2; wherein the substrate is made from two or more woven reinforcing materials of different or identical type(s).

9. A papermaking felt according to claim 3; wherein the substrate is made from two or more woven reinforcing materials of different or identical type(s).

10. A papermaking felt according to claim 4; wherein the substrate is made from two or more woven reinforcing materials of different or identical type(s).

11. A papermaking felt according to claim 6; wherein the substrate is made from two or more woven reinforcing materials of different or identical type(s).

12. A papermaking felt according to claim 7; wherein the substrate is made from two or more woven reinforcing materials of different or identical type(s).
